(19) United States
(12) Patent Application Publication
(10) Pub. No.: US 2014/0068953 A1
(43) Pub. Date: Mar. 13, 2014

(54) Safety Razor

(71) Applicant: Eveready Battery Company Inc., St Louis, MO (US)

(72) Inventor: Jeffrey Wonderley, Fort Defiance, VA (US)

(73) Assignee: Eveready Battery Company Inc., St Louis, MO (US)

(21) Appl. No.: 13/973,032

(22) Filed: Aug. 22, 2013

Related U.S. Application Data
(60) Provisional application No. 61/698,795, filed on Sep. 10, 2012.

(51) Int. Cl. B26B 21/52

(52) U.S. Cl. CPC B26B 21/521
USPC 30/527

(57) ABSTRACT

A safety razor has a handle including an arm moveable relative to the handle and terminating in handle connecting structure engageable with cartridge connecting structure of a razor cartridge. The safety razor has a flexible spring finger having an end portion. The spring finger is integrally formed with one of a housing of the razor cartridge and the arm, and the other of the housing and the arm includes blocking structure having a blocking surface. The end portion of the spring finger is closely spaced from the blocking surface to prevent movement of the arm relative to the housing sufficient to disengage the handle pivoting connecting structure from the cartridge pivoting connecting structure thereby preventing accidental release of the razor cartridge from the handle.

### CROSS REFERENCE TO RELATED APPLICATIONS

This application claims the benefit of U.S. provisional patent application Ser. No. 61/698,795, filed Sep. 10, 2012, the content of which is incorporated herein for reference in its entirety.

### TECHNICAL FIELD

The present disclosure relates to safety razors, and more specifically to elements to securely attach a razor cartridge to a handle.

### BACKGROUND

Many modern wet shaving razors, also known as safety razors, comprise a handle and a razor cartridge mounted to the handle. Some razors are so-called disposable razors wherein the handle and razor cartridge together are disposed of after use. Alternatively, the razor may be in the form of a so-called system that comprises a longer term use handle that is reused and a removable and disposable razor cartridge that is disposed after use and can be replaced with a new cartridge. The razor cartridge includes a housing having razor blade(s) with sharpened cutting edge(s). The razor cartridge and the handle can each include engageable respective pivoting connecting structure whereby the razor cartridge can pivot about a pivot axis with respect to the handle.

For many reasons (e.g. manufacturing and economic) it is not usual to provide a disposable razor with suitable means to enable a user to easily engage or disengage a razor cartridge, while this is typically provided for a user of a system razor. In the event that a disposable razor undergoes abuse, e.g. it is dropped from some height onto a hard surface, and depending on the orientation at impact, it is possible for the razor cartridge to become wholly or partially detached from the handle. A user can then have difficulties reattaching the razor cartridge or may unknowingly use the razor with the razor cartridge only partially attached to the handle which can result in less safe operation of the razor, e.g. the user might experience nicks and cuts.

### SUMMARY

The present disclosure has for its objective to eliminate, or at least substantially alleviate the limitations of the prior art by providing a safety razor including a razor cartridge mounted to a handle in an improved manner. The handle has an arm terminating in handle pivoting connecting structure. The handle pivoting connecting structure is engaged with cartridge pivoting connecting structure of the housing of the razor cartridge to permit the razor cartridge to pivot relative to the handle about the pivot axis. The arm is moveable relative to the handle sequentially along a release direction and an opposed load direction, both generally along the pivot axis, to engage the handle pivoting connecting structure with the cartridge pivoting connecting structure of the razor cartridge as the handle is moved relative to the razor cartridge along a mount direction to mount the razor cartridge to the handle. The safety razor also has a spring finger having an end portion and that is flexible in a direction opposed to the mount direction. The spring finger is integrally formed with one of the housing and the arm and the other of the housing and the arm includes blocking structure having a blocking surface generally perpendicular to the pivot axis. The end portion of the spring finger is closely spaced from the blocking surface to prevent movement of the arm relative to the housing along the release direction sufficient to cause disengagement of the respective pivoting connecting structures and thereby release of the razor cartridge from the handle.

In some aspects the razor cartridge comprises a pair of cartridge pivoting connecting structures and the handle includes a pair of arms, each arm terminating in handle pivoting connecting structure and where each respective handle pivoting connecting structure is engaged with respective cartridge pivoting connecting structure of the razor cartridge. The safety razor can further comprise a pair of spring fingers each having a respective end portion, and a pair of blocking surfaces and wherein the end portion of each spring finger is closely spaced from a respective blocking surface.

These and other advantages of the present disclosure will be apparent to one of ordinary skill in the art in light of the following Detailed Description and Drawings.

### BRIEF DESCRIPTION OF THE DRAWINGS

Reference is made to the attached drawings, wherein elements having the same reference numeral designations represent like elements throughout, and wherein:

FIG. 1 is a schematic view of embodiments of a razor cartridge and a portion of a razor handle;

FIG. 2 is a schematic view of the elements of FIG. 1 during an assembly operation;

FIG. 3 is a schematic view of the elements of FIG. 1 assembled to provide an embodiment of a safety razor;

FIG. 4 is a schematic view of another embodiment of a safety razor;

FIG. 5 is a plan view of a further embodiment of a safety razor;

FIG. 6 is a side view of the safety razor of FIG. 5;

FIG. 7 is a plan view of a connector of the safety razor of FIG. 5; and

FIG. 8 is a schematic view of a still further embodiment of a safety razor.

### DETAILED DESCRIPTION

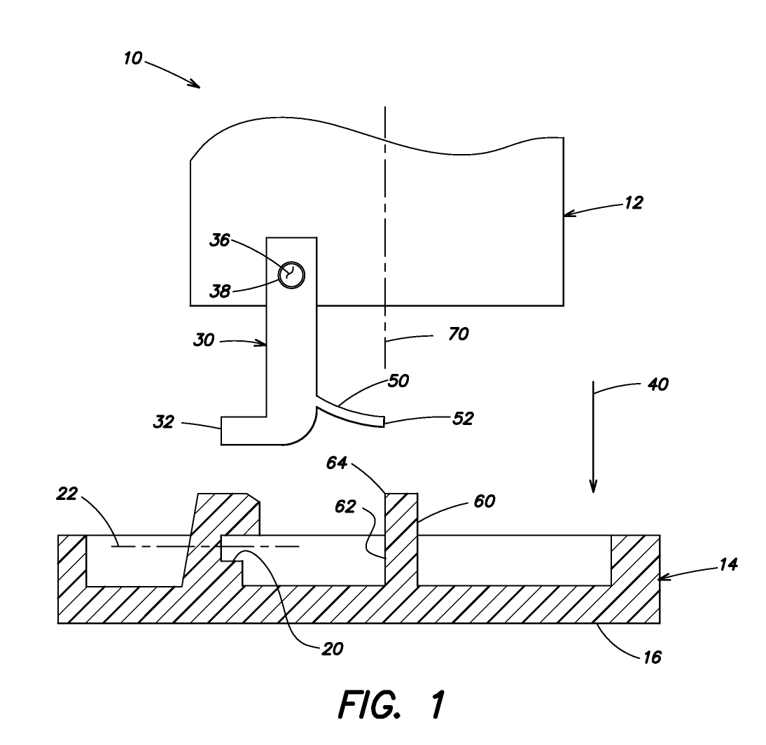

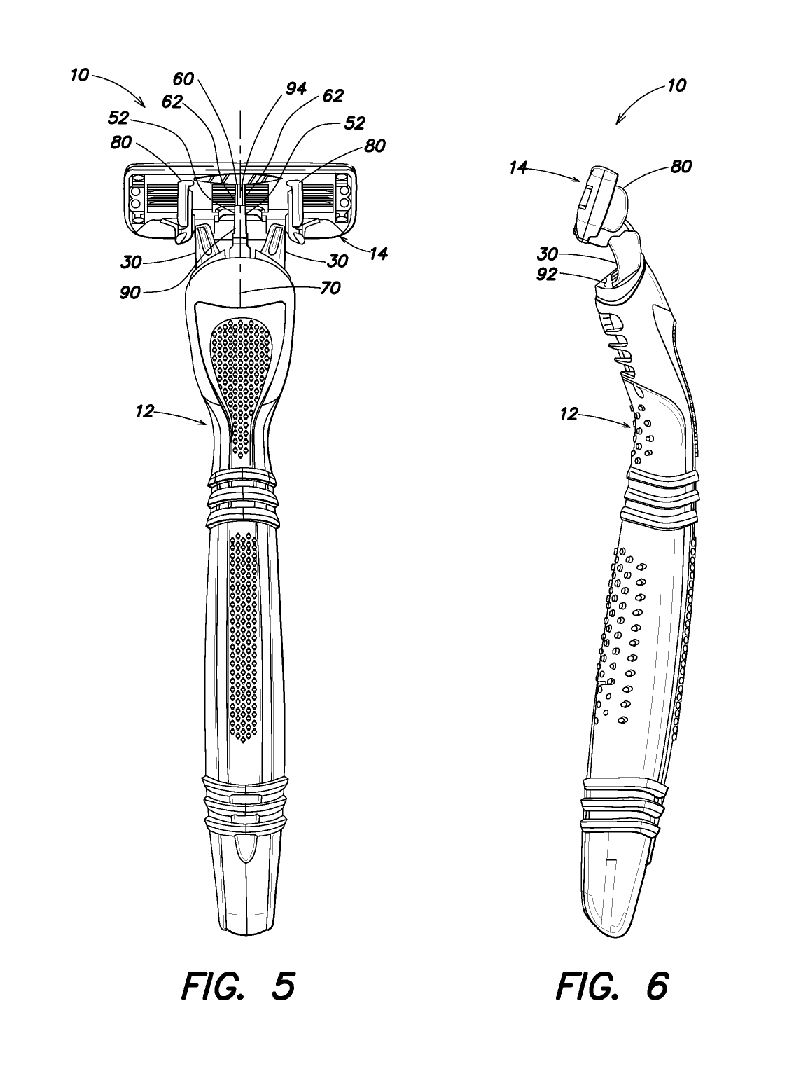

Referring to the drawings and in particular FIG. 1 and FIGS. 2-3, a safety razor 10 includes a handle 12 (a head portion only being shown in these figures for the benefit of clarity of depiction) and a razor cartridge 14 comprising a housing 16. The housing 16 includes cartridge pivoting connecting structure 20 defining a pivot axis 22. The handle 12 has an arm 30 terminating in handle pivoting connecting structure 32. As depicted in the embodiment of these figures, the respective pivoting connecting structures include a pin that engages with a hole. Both the pin and hole define cooperating cylindrical surfaces (respectively external and internal) such that the pin can pivot in the hole and thus the razor cartridge 14 can pivot relative to the handle 12 about pivot axis 22 when the razor cartridge 14 is mounted on the handle 12. Other types of pivoting connecting structure are within the scope of the present disclosure and the present disclosure is not limited in this regard. For example, the pin and hole arrangement can be reversed such that the handle 12 carries the hole and the housing 16 carries the pin. Alternatively, the pivoting connecting structures can include engageable shell bearing structures as depicted in FIGS. 5-6 and discussed later in the present disclosure. Further types of pivoting connecting structure such as living hinge arrangements etc. are also within the scope of the present disclosure. In FIGS. 1-4 and 8 a single cartridge pivoting connecting structure 20 and handle pivoting connecting structure 32 are shown for the benefit of clarity of depiction. As is shown in FIGS. 5-7 a pair of respective connecting structures 20, 32 can also be provided.

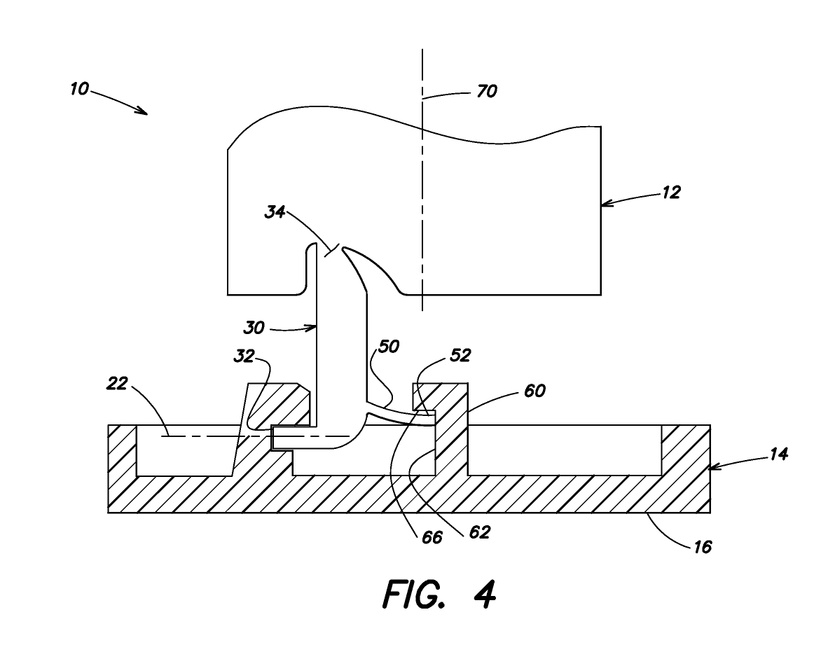

Arm 30 of handle 12 is moveable relative to the handle, e.g. via an actuating button and associated mechanism (not shown) or via elements of manufacturing apparatus to assemble the safety razor, as known to the skilled worker. This movement can be by elastic deflection of a deflectable portion 34 (see FIG. 4) or by an axle 36 in a respective hole 38 (see FIGS. 1-3) or by another suitable method, for example the arm 30 can slide linearly relative to the handle (see FIG. 8 and the accompanying description later in the present disclosure).

In a sequence to assemble the razor cartridge 14 and handle 12, the handle 12 is moved relative to the razor cartridge 14 in a mount direction 40. Generally simultaneously the arm moves in a release direction 42, generally along the pivot axis 22 and subsequently in an opposed load direction 44 to complete the engagement of the respective pivoting connecting structures. In the context of the present disclosure, the term ‘generally along the pivot axis’ is intended to encompass linear movement and/or radial movement generally tangentially along the pivot axis. In this embodiment the release direction is in a direction towards a center plane 70 of the razor handle 12. In other embodiments (as discussed later in the present disclosure) the release direction 42 can be in a direction away from the center plane 70.

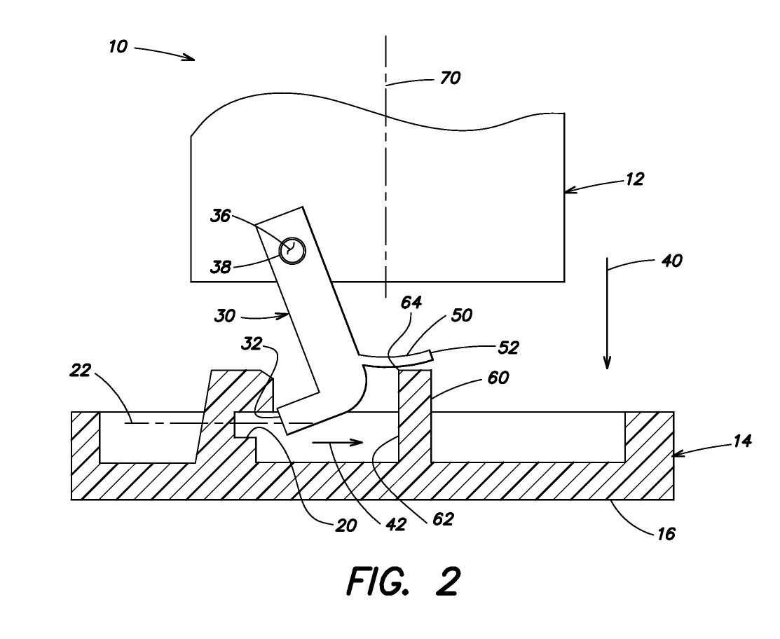

The safety razor includes a spring finger 50 having an end portion 52. The spring finger is flexible in a direction opposed to the mount direction 40 (as depicted in FIG. 2). In the embodiment depicted in these figures the spring finger is shown as an integral part of the arm 30. The safety razor also includes blocking structure 60 having a blocking surface 62 disposed generally perpendicular to the pivot axis 22. In the embodiment depicted in these figures the blocking structure is shown as an integral part of the housing 16 and the blocking surface is an interior (i.e. not exterior) surface of the housing. Other locations for the spring finger and blocking structure are within the scope of the present disclosure and the present disclosure is not limited in this regard. An example is shown in FIG. 8 and the accompanying description later in the present disclosure.

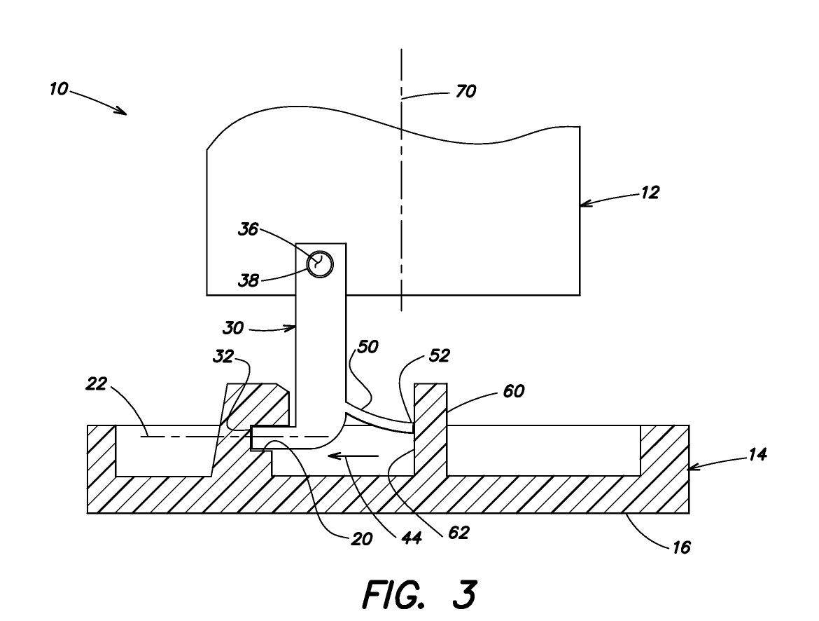

As depicted in FIG. 3, the end portion 52 of the spring finger 50 is closely spaced from the blocking surface 62. In the event that the safety razor undergoes abuse, e.g. impact from being accidentally dropped, movement of the arm relative to the housing in the release direction sufficient to disengage the respective pivoting connecting structures is prevented by the end portion 52 of the arm abutting the blocking surface 62. Thereby, accidental release of the razor cartridge 14 from the handle 12 is prevented or significantly inhibited.

As depicted in FIG. 2, the spring finger 50 is provided with flexibility as discussed in order that the end portion 52 can pass over e.g. any outer corner 64 of the blocking structure 60 or other interfering structure during an assembly sequence.

As depicted in FIG. 4, the blocking structure 60 can further be provided with an inwardly facing surface 66 generally perpendicular to the mount direction. In this embodiment the end portion 52 of the spring finger 50 is further closely spaced from the inwardly facing surface 66 to prevent movement of the arm relative to the housing in a direction opposed to the mount direction to further prevent release of the razor cartridge from the handle.

Turning now to FIG. 8, another embodiment of a safety razor 10 is depicted. In this embodiment the spring finger 50 is integrally formed with the housing 16 of the razor cartridge 14. In this embodiment the arm 30 of the handle 12 also comprises the blocking structure 60. In this embodiment the arm 30 is moveable relative to the handle by sliding. The arm 30 can include a protrusion 100 (extending in one or both directions out of the plane of the figure) that engages a cooperating slot 102 of the handle enabling the arm 30 to slide along the slot 102. The end portion 52 of the spring finger 50 is closely spaced from the blocking surface 62 of the blocking structure 60. Furthermore in this embodiment the release and load directions are reversed relative to the embodiments of FIGS. 1-3 and 4, that is, the release direction 42 is away from the center plane 70 of the handle 12. Once again, movement of the arm relative to the housing in the release direction sufficient to disengage the respective pivoting connecting structures is prevented. Thereby again, accidental release of the razor cartridge 14 from the handle 12 is prevented or significantly inhibited.

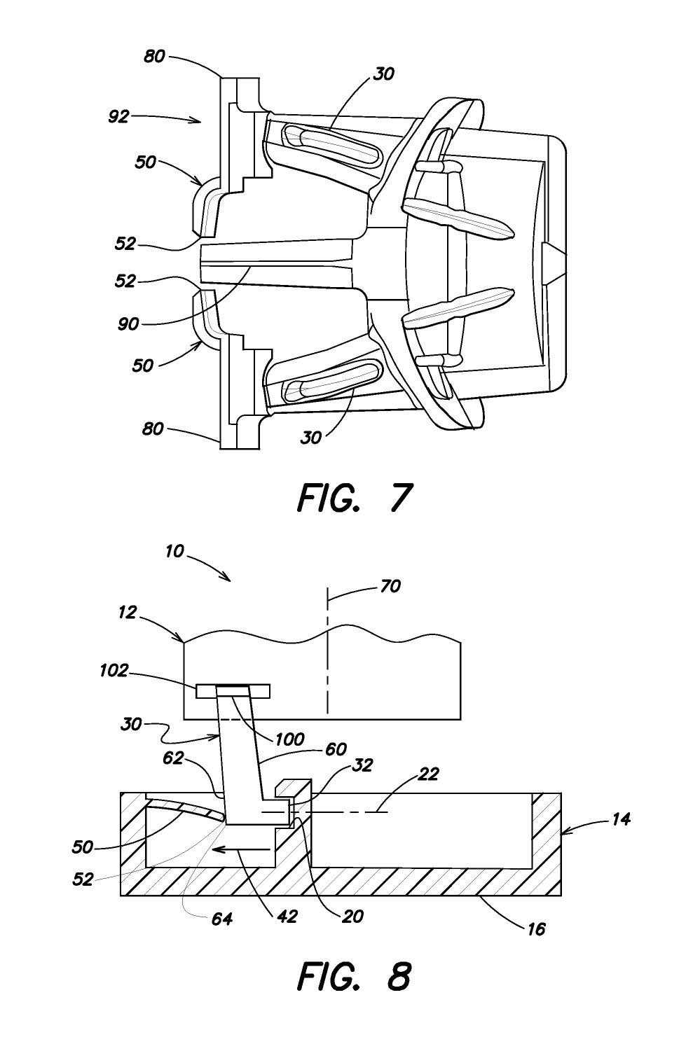

Turning now to FIGS. 5-6, another embodiment of a safety razor 10 is depicted. This embodiment is similar to the embodiment of FIGS. 1-3 with an exception that the respective pivoting connecting structures are a pair of engageable shell bearing structures 80. In this embodiment the handle 12 comprises a pair of arms 30, each terminating handle connecting structure 82. Each arm 30 has a spring finger 50. In this embodiment the arms 30 are integrally formed with a connector 92 (depicted in FIG. 7) that is received in a cavity of the handle 12. The connector also comprises a biasing member 90 provided to return the razor cartridge to a neutral position relative to the handle when certain loads, e.g. shaving forces, are removed from the safety razor. The blocking structure 60 of the housing 16 of the razor cartridge also serves the function of providing a cam surface 94 that the biasing member 90 acts against. A pair of blocking surfaces 62 is provided. Each respective end portion 52 of each spring finger 50 is closely spaced from a blocking surface 62. Movement of one or both arms 30 relative to the housing 16 in respective release directions sufficient to disengage the respective shell bearing pivoting connecting structures is prevented. Thereby, accidental release of the razor cartridge 14 from the handle 12 is prevented or significantly inhibited.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. For instance, features disclosed in connection with any one embodiment can be used alone or in combination with each feature of the respective other embodiments.

What is claimed is:

1. A safety razor, comprising:
a razor cartridge comprising a housing including cartridge pivoting connecting structure defining a pivot axis;
wherein the razor cartridge is mounted to a handle having an arm terminating in handle pivoting connecting structure, the handle pivoting connecting structure being engaged with the cartridge pivoting connecting structure of the razor cartridge to permit the razor cartridge to pivot relative to the handle about the pivot axis;
wherein the arm is moveable relative to the handle sequentially along a release direction and an opposed load direction, both generally along the pivot axis, to engage the handle pivoting connecting structure with the cartridge pivoting connecting structure of the razor cartridge as the handle is moved relative to the razor cartridge along a mount direction to mount the razor cartridge to the handle;
wherein the safety razor further includes a spring finger having an end portion and being flexible in a direction opposed to the mount direction;
wherein the spring finger is integrally formed with one of the housing and the arm, and the other of the housing and the arm includes blocking structure having a blocking surface generally perpendicular to the pivot axis; and
wherein the end portion of the spring finger is closely spaced from the blocking surface to prevent movement of the arm relative to the housing along the release direction sufficient to disengage the handle pivoting connecting structure from the cartridge pivoting connecting structure thereby releasing the razor cartridge from the handle.

2. The safety razor of claim 1, the arm is moveable relative to the handle by one of pivoting, elastic deformation and sliding.

3. The safety razor of claim 2, wherein the handle includes a connector and wherein the arm is one of mounted to and integrally formed with the connector.

4. The safety razor of claim 1, wherein when the blocking surface is on the housing, the blocking surface is an interior surface of the housing.

5. The safety razor of claim 1, wherein the release direction is toward a center plane of the handle.

6. The safety razor of claim 4, wherein the housing further includes a cam and the blocking surface is a side surface of the cam.

7. The safety razor of claim 1, wherein the handle pivoting connecting structure comprises one of a pin defining a cylindrical exterior surface and shell bearing structure.

8. The safety razor of claim 1, wherein the blocking structure further includes an inwardly facing surface generally perpendicular to the mount direction and the end portion of the spring finger is further closely spaced from the inwardly facing surface to prevent movement of the arm relative to the razor cartridge in a direction opposed to the mount direction to thereby prevent release of the razor cartridge from the handle.

9. The safety razor of claim 1, wherein the razor cartridge comprises a pair of cartridge pivoting connecting structures and the handle includes a pair of arms, each arm terminating in handle pivoting connecting structure, each respective handle pivoting connecting structure being engaged with respective cartridge pivoting connecting structure of the razor cartridge.

10. The safety razor of claim 1, wherein the safety razor further comprises a pair of spring fingers each having a respective end portion, and a pair of blocking surfaces and wherein the end portion of each spring finger is closely spaced from the respective blocking surface.

12. The safety razor of claim 3, wherein the razor cartridge comprises a pair of cartridge pivoting connecting structures and the connector includes a pair of arms, each arm terminating in handle pivoting connecting structure, each respective handle pivoting connecting structure being engaged with respective cartridge pivoting connecting structure of the razor cartridge.
